(19) United States
(12) Patent Application Publication
(10) Pub. No.: US 2020/0038142 A1
(43) Pub. Date: Feb. 6, 2020

(54) Retainer Engaging the Gums and a Method for Creating Such

(71) Applicant: Khaled Eldin, Old Bridge, NJ (US)

(72) Inventor: Khaled Eldin, Old Bridge, NJ (US)

(21) Appl. No.: 16/217,608

(22) Filed: Dec. 12, 2018

Related U.S. Application Data
(63) Continuation-in-part of application No. 16/055,419, filed on Aug. 6, 2018, now abandoned.

(51) Int. Cl. A61C 7/08; A61C 9/00

(52) U.S. Cl. CPC A61C 7/08; A61C 9/0006

(57) ABSTRACT

A method of creating a retainer for engaging gums and teeth of a specific user. The method includes, at an initial step, creating a mold of the gums and teeth of the specific user. Indentations are placed into the mold along a gum-line between modeled gums and teeth. Subsequently, and using the mold with the indentations, a retainer is formed, such that the retainer includes protrusions, each of the protrusions corresponding to one of the indentations. The retainer matches the shape of the teeth and the gums of the specific user except for the protrusions, and when the retainer is worn by the specific user, the protrusions push on the gum-line of the specific user, thereby ensuring engagement of the retainer to the teeth and the gums of the specific user.

### FIELD OF THE DISCLOSED TECHNOLOGY

The disclosed technology relates generally to retainers for aligning teeth, and, more specifically, to a retainer for aligning teeth which engages the gums and which is formed by making indentations in a mold of the teeth at the base of each tooth, to create a corresponding protrusion in the retainer, which protrusion pushes against the gums and ensures the correct placement of the retainer.

### BACKGROUND OF THE DISCLOSED TECHNOLOGY

Many people who have crooked or misaligned teeth, wish to have their teeth aligned, whether for medical reasons or for aesthetic reasons.

Retainers, also known as bite plates, are also often used as part of the process of straightening teeth, either to actively change the position or orientation of one or more teeth, or to retain the aligned position of the teeth reached by braces or other orthodontic tools. However, prior art retainers can easily move relative to the wearer's teeth, particularly if they do not contact or apply mild pressure to the gums. For example, some users unintentionally remove their retainers (e.g. by the tongue) while they are sleeping or eating.

However, there remains a need in the art for a retainer which engages the gums such that the user cannot easily move the retainer, or remove it from the teeth, for example while sleeping.

### SUMMARY OF THE DISCLOSED TECHNOLOGY

According to an aspect of some embodiments of the teachings herein, there is provided a method of creating a retainer for engaging gums and teeth of a specific user. The method includes, at an initial step, creating a mold of the gums and teeth of the specific user. Indentations are placed into the mold along a gum-line between modeled gums and teeth. Subsequently, and using the mold with the indentations, a retainer is formed, such that the retainer includes protrusions, each of the protrusions corresponding to one of the indentations. The retainer matches the shape of the teeth and the gums of the specific user except for the protrusions, and when the retainer is worn by the specific user, the protrusions push on the gum-line of the specific user, thereby ensuring engagement of the retainer to the teeth and the gums of the specific user.

In some embodiments, at least one indentation is placed in a front gum-line of at least one of the teeth in the mold. In some embodiments, at least one indentation is placed in a back gum-line of at least one of the teeth in the mold.

In some embodiments, at least one indentation is placed in each of a front gum-line and a back gum-line of at least one of the teeth in the mold. In some embodiments, at least one indentation is placed in each of a front gum-line and a back gum-line of each of the teeth in the mold.

According to another aspect of some embodiments of the teachings herein, there is provided a mold for creating a retainer for engaging teeth and gums of a specific user. The mold is formed from a model of the teeth of the specific user, and includes at least one indentation formed along a region corresponding to a gum-line adjacent at least one tooth of the specific user. The retainer formed using the mold is adapted to apply more pressure to the gum-line of the specific user adjacent the at least one tooth of the specific user compared to a second retainer created from the mold before adding the at least one indentation.

In some embodiments, the retainer is adapted to ensure tighter engagement of the retainer to the teeth and gums of the specific user compared to the second retainer.

According to yet another aspect of some embodiments of the teachings herein, there is provided a retainer for aligning teeth of a specific user, formed using the mold described herein. The retainer includes a trough having a shape corresponding in shape to a shape of the teeth of the specific user and adapted to be mounted thereon. The retainer further includes at least one protrusion corresponding to the at least one indentation, such that when the specific user wears the retainer, the at least one protrusion applies pressure along the gum-line adjacent the at least one tooth of the specific user. Thus, the at least one protrusion ensures tighter engagement of the retainer to the teeth and gums of the specific user.

In some embodiments, the at least one protrusion is formed in a surface of the trough engaging a front gum-line of at least one of the teeth, or of each of the teeth.

In some embodiments, the at least one protrusion is formed in a surface of the trough engaging a back gum-line of at least one of the teeth, or of each of the teeth.

In some embodiments, the at least one protrusion includes a first protrusion formed in a surface of the trough engaging a front gum-line of at least one of the teeth, or of each of the teeth, of the specific user and a second protrusion formed in a surface of the trough engaging a back gum-line of the at least one of the teeth, or of each of the teeth, of the specific user.

### BRIEF DESCRIPTION OF THE DRAWINGS

FIGS. 1A and 1B are, respectively, perspective view illustrations of a retainer mold including a model of a user's teeth, before and after forming indentations in the retainer mold according to an embodiment of the disclosed technology.

FIGS. 2A and 2B are, respectively, perspective view illustrations of the retainer mold of FIGS. 1A and 1B, having a retainer formed thereon.

FIGS. 3A and 3B are, respectively, perspective view illustrations of retainers formed on the retainer molds of FIGS. 1A and 1B, according to an embodiment of the disclosed technology.

FIGS. 4A and 4B are, respectively, sectional illustrations of the retainers and retainer molds of FIGS. 2A and 2B, the sectional illustrations being taken along section lines IVA-IVA and IVB-IVB in FIGS. 2A and 2B, respectively.

### DETAILED DESCRIPTION OF EMBODIMENTS OF THE DISCLOSED TECHNOLOGY

In an embodiment of the disclosed technology, a retainer is molded with a protrusion extending along the gum-line, which protrusion engages the gums of the wearer of the retainer. The protrusion in the retainer is formed by creating a corresponding indentation in the mold used for creating the retainer. The location of the protrusion is specifically selected to ensure that the retainer be tightly held onto the wearer's teeth.

According to an aspect of some embodiments of the teachings herein, there is provided a method of creating a retainer for engaging gums and teeth of a specific user. The method includes, at an initial step, creating a mold of the gums and teeth of the specific user. Indentations are placed into the mold along a gum-line between modeled gums and teeth. Subsequently, and using the mold with the indentations, a retainer is formed, such that the retainer includes protrusions, each of the protrusions corresponding to one of the indentations. The retainer matches the shape of the teeth and the gums of the specific user except for the protrusions, and when the retainer is worn by the specific user, the protrusions push on the gum-line of the specific user, thereby ensuring engagement of the retainer to the teeth and the gums of the specific user.

In the context of the present specification and claims, the term “gum-line” of a tooth, relates to the gingival line of that tooth, on the buccal and/or lingual side of the tooth.

In the context of the present application and claims, the terms “front side” and “outer side” of a tooth are used interchangeably, and relate to the buccal surface of the tooth.

In the context of the present application and claims, the terms “front gum-line” or “outer gum-line” are used interchangeably, and relate to the gingival line adjacent the buccal surface of the tooth.

In the context of the present application and claims, the terms “back side” and “inner side” of a tooth are used interchangeably, and relate to the lingual surface of the tooth.

In the context of the present application and claims, the terms “back gum-line” or “inner gum-line” are used interchangeably, and relate to the gingival line adjacent the lingual surface of the tooth.

In the context of the present application and claims, the phrase “placing an indentation” in a model or mold relates to creating an indentation in the model by any suitable means, including scraping or otherwise removing material from the model or mold following forming thereof, or creating the model or mold with indentations therein, for example by including the indentation in an electronic representation of the model or mold, and 3D printing of the model or mold from the electronic representation.

Embodiments of the disclosed technology will become clearer in view of the following description of the drawings.

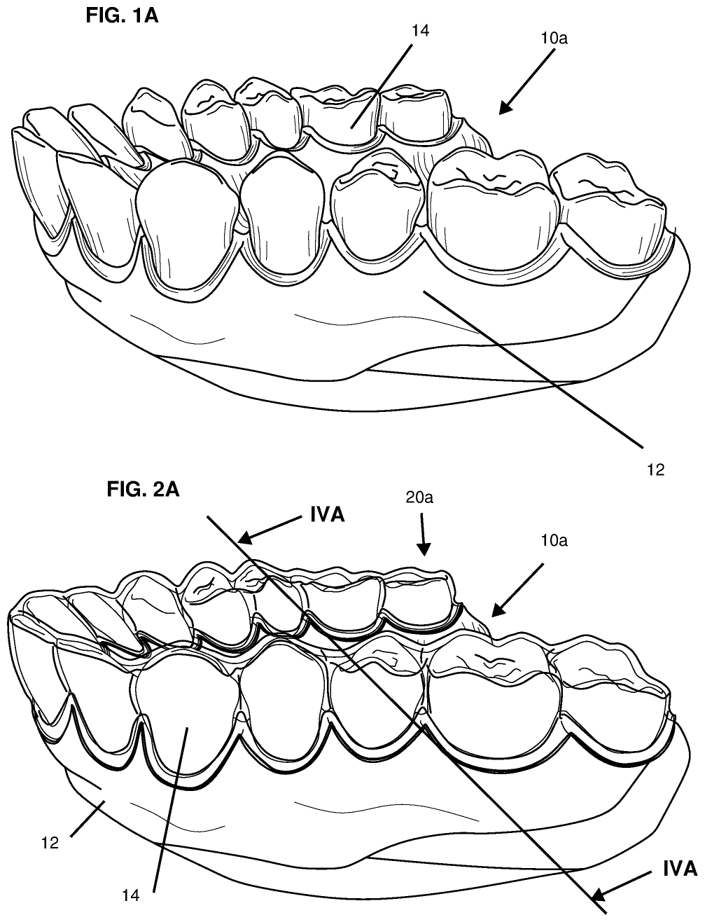

FIGS. 1A and 1B are, respectively, perspective view illustrations of retainer molds 10a and 10b, each including a model of a user's teeth, before and after forming indentations in the retainer mold according to an embodiment of the disclosed technology.

As seen, each of retainer molds 10a and 10b includes a model of the user's lower gums 12 and of the user's lower teeth 14. However, corresponding molds could be formed to model the upper gums and teeth of the user.

As clearly visible from a comparison of molds 10a and 10b, mold 10b differs from mold 10a by an indentation 16a extending along the entire inner gum-line 18a and an indentation 16b extending along the entire outer gum-line 18b. Indentations 16a and 16b may be formed in the mold 10a of FIG. 1A, for example by scraping away some of the material of the mold, in order to obtain mold 10b of FIG. 1B. In some embodiments, indentations 16a and/or 16b may extend only along part of the gum-lines 18a and/or 18b, respectively.

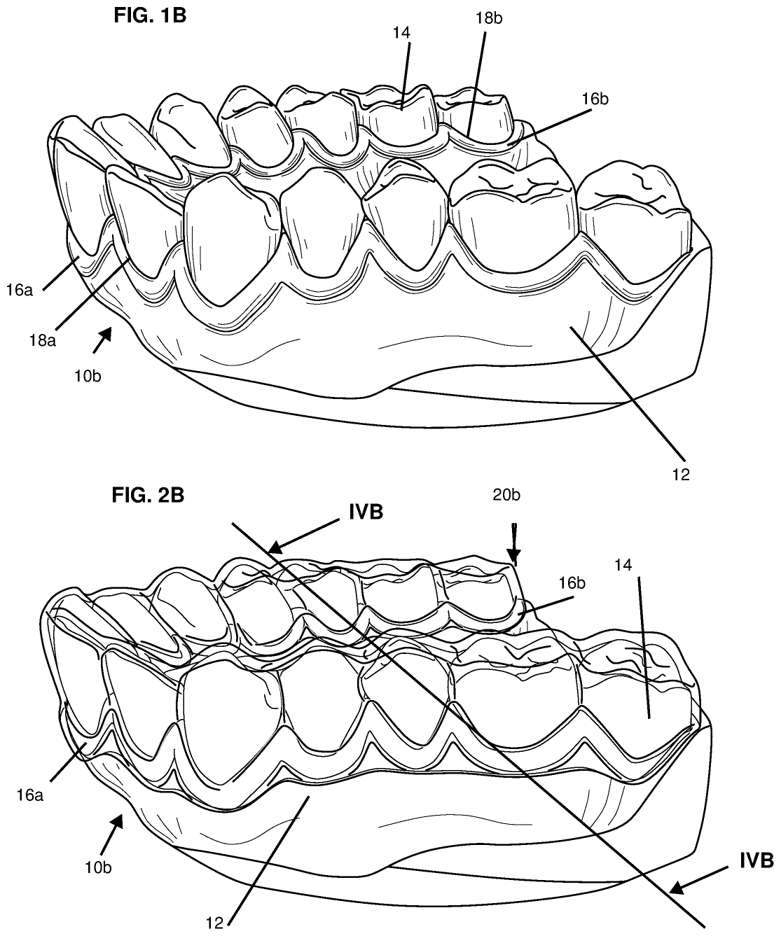

Referring additionally to FIGS. 2A and 2B, it is seen that each of molds 10a and 10b has formed thereon a corresponding retainer 20a and 20b, which engages the modeled teeth 14 as well as the modeled gum-lines. Specifically, retainer 20b engages indentations 16a and 16b in mold 10b. The illustrated retainers 20a and 20b are transparent.

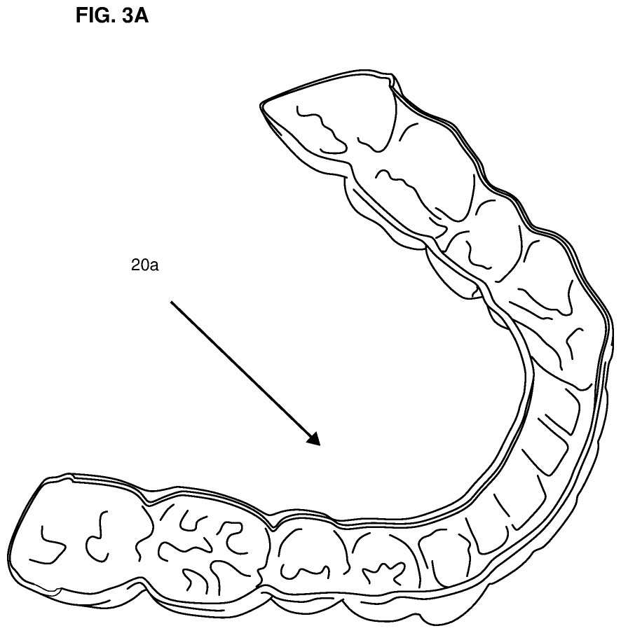

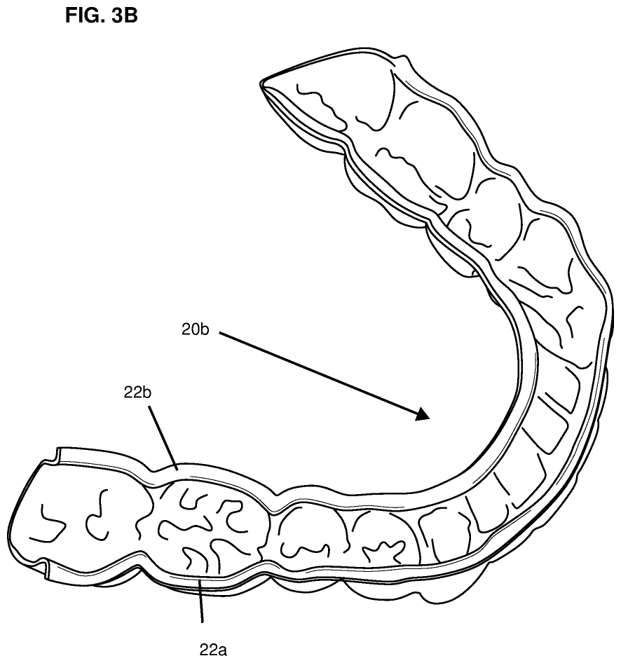

FIGS. 3A and 3B are perspective view illustrations of trough shaped retainers 20a and 20b formed on the retainer molds 10a and 10b of FIGS. 1A and 1B, respectively. As seen from comparison of FIGS. 3A and 3B, the retainer 20b formed on mold 10b of FIG. 1B includes a first protrusion 22a corresponding to indentation 16a in mold 10b, and a second protrusion 22b corresponding to indentation 16b in mold 10b.

In the retainer 20b of FIG. 3B, protrusion 22a is located along the edge of the trough shape, along an inner curve thereof, and is adapted to engage the inner gum-line of the user of the retainer. Protrusion 22b is located along the edge of the trough shape, along an outer curve thereof, and is adapted to engage the outer gum-line of the user of the retainer.

Retainer 20b illustrated herein includes protrusions 22a and 22b on both the inner and outer sides of the retainer, so as to improve the engagement between the retainer and the gums. However, in some embodiments, the mold 10a may be modified to include only one of indentations 16a and 16b, such that the resulting retainer would include only one of protrusions 22a and 22b. Such a retainer may be suitable for applying pressure to the entire arc of the teeth, for example for translation of all the teeth inward or outward.

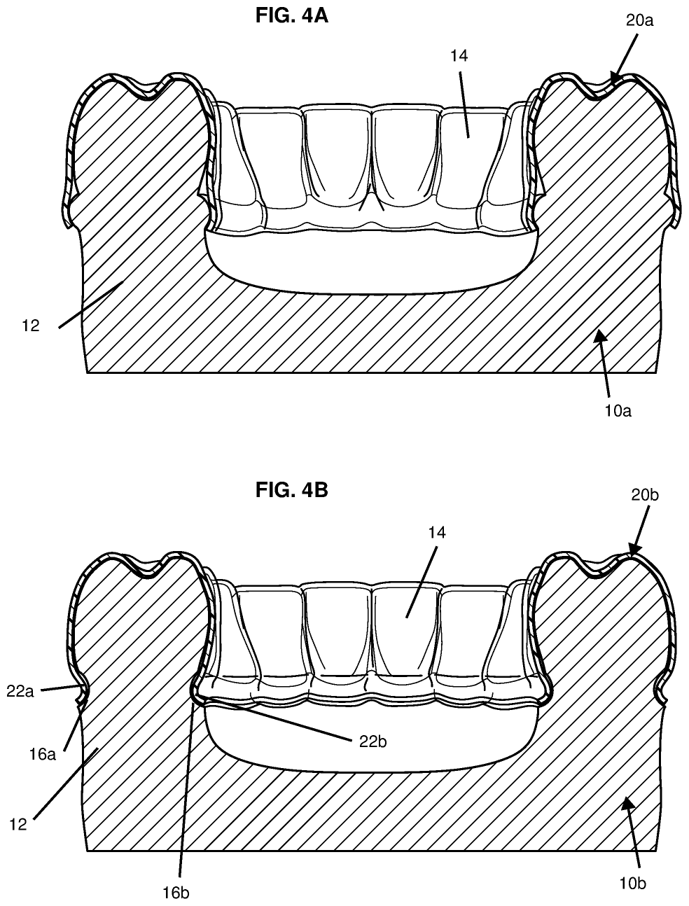

Reference is additionally made to FIGS. 4A and 4B, which are, respectively, sectional illustrations of the retainers 20a and 20b disposed on corresponding retainer molds 10a and 10b. As seen, indentations 22a and 22b in retainer 20b engage protrusions 16a and 16b, and would, when the retainer 20b is worn by the user, apply pressure to the gum line so as to prevent accidental removal of the retainer. By contrast, the width of retainer 20a at the gum-line is determined by the widest portion of the gum line, such that the retainer engages a bulge in the gums, and can be easily removed from the teeth, intentionally or accidentally.

The above-described devices and methods can also be used with retainers constructed from molds of the teeth which have protrusions to move the teeth through rotation (spinning on a central axis), translation (movement laterally), or tilting (changing the angle of the tooth with respect to the jawbone) thereof. This can be carried out using multiple retainers, first with retainers which are narrower on the gums (on a side of the tooth which attaches nearest to the jawbone) as described above. These retainers lift the tooth out of the gums slightly, such as a matter of a millimeter. Successive retainers which are tighter on the tooth or based on new molds as the teeth or a single tooth moves upwards from the gums are used in embodiments of the disclosed technology. This loosens or stretches the ligaments holding the tooth and then the teeth can be moved more effectively in other ways, such as the rotation, translation, or tiling thereof. Thus, a second retainer or set of retainers are used to carry out same after the tooth has been slightly lifted.

The first type of retainer (narrower at the gums) can be used over a period of about 6, 9, or 12 months followed by the second type with protrusions causing rotation, translation, and or tilting. The number of retainers used can be 1, 6, 12, or more of each first and second type, the second type following the first type. This allows for easier and quicker expansion of an arch an mimics the vibration effect on the osteoclasts cells by lifting and then moving the tooth in another direction only after the lifting. The lifting and rotation/translation can also be alternated, if needed.

It will be appreciated that though the illustrated embodiments each show a single type of motion (translation, rotation, or tilting) on a single tooth, suitable indentations may be formed in a mold so as to move a single tooth in multiple direction, as required for alignment of the tooth. For example, a single tooth may be tilted backwards and rotated to the right, by appropriate placement of protrusion on the retainer, and of corresponding indentations on the mold. Similarly, it will be appreciated that a single retainer may include multiple protrusions for simultaneously affecting multiple teeth as required, and that the corresponding mold would include multiple corresponding indentations in the mold of multiple of the user's teeth.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods and apparatuses described hereinabove are also contemplated and within the scope of the invention.

1. A method of creating a retainer for engaging gums and teeth of a specific user, the method comprising:
creating a mold of the gums and teeth of said specific user;
placing indentations into said mold along a gum-line between modeled gums and teeth; and
using said mold with said indentations, forming a retainer, such that said retainer includes protrusions, each of said protrusions corresponding to one of said indentations,
wherein said retainer matches the shape of said teeth and said gums of said specific user except for said protrusions, and wherein when said retainer is worn by said specific user, said protrusions push on said gum-line of said specific user, thereby ensuring engagement of said retainer to said teeth and said gums of said specific user.

2. The method of claim 1, wherein said placing indentations comprises placing at least one indentation in a front gum-line of at least one of said teeth in said mold.

3. The method of claim 1, wherein said placing indentations comprises placing at least one indentation in a back gum-line of at least one of said teeth in said mold.

4. The method of claim 1, wherein said placing indentations comprises placing an indentation in a front gum-line and an indentation in a back gum-line of at least one of said teeth in said mold.

5. The method of claim 4, wherein said placing indentations comprises placing an indentation in said front gum-line and an indentation in said back gum-line of each of said teeth in said mold.

6. A mold for creating a retainer for engaging teeth and gums of a specific user, said mold formed from a model of said teeth of said specific user, and including at least one indentation formed along a region corresponding to a gum-line adjacent at least one tooth of said specific user;
wherein said retainer formed using said mold is adapted to apply more pressure to said gum-line of said specific user adjacent said at least one tooth of said specific user compared to a second retainer created from said mold before adding said at least one indentation.

7. The mold of claim 6, wherein said retainer is adapted to ensure tighter engagement of said retainer to said teeth and gums of said specific user compared to said second retainer.

8. A retainer for aligning teeth of a specific user, formed using the mold of claim 6, said retainer including a trough having a shape corresponding in shape to a shape of said teeth of said specific user and adapted to be mounted thereon, and at least one protrusion corresponding to said at least one indentation, such that when said specific user wears said retainer, said at least one protrusion applies pressure along said gum-line adjacent said at least one tooth of said specific user, thereby ensuring tighter engagement of said retainer to said teeth and gums of said specific user.

9. The retainer of claim 8, wherein said at least one protrusion is formed in a surface of said trough engaging a front gum-line of at least one of said teeth of said specific user.

10. The retainer of claim 9, wherein said at least one protrusion is formed in a surface of said trough engaging a front gum-line of each of said teeth of said specific user.

11. The retainer of claim 8, wherein said at least one protrusion is formed in a surface of said trough engaging a back gum-line of at least one of said teeth of said specific user.

12. The retainer of claim 11, wherein said at least one protrusion is formed in a surface of said trough engaging a back gum-line of each of said teeth of said specific user.

13. The retainer of claim 8, wherein said at least one protrusion includes a first protrusion formed in a surface of said trough engaging a front gum-line of at least one of said teeth of said specific user and a second protrusion formed in a surface of said trough engaging a back gum-line of said at least one of said teeth of said specific user.

14. The retainer of claim 13, wherein said at least one protrusion includes a first protrusion formed in a surface of said trough engaging said front gum-line of each of said teeth of said specific user and a second protrusion formed in a surface of said trough engaging said back gum-line of each of said teeth of said specific user.

15. A method of creating a plurality of retainers for aligning teeth of a specific user, the method comprising:
creating a plurality of molds of the teeth of the specific user;
placing indentations into at least one mold of said plurality of molds along a gum-line between modeled gums and teeth and using same to form a first retainer or set of first retainers;
placing indentations into at least one mold of said plurality of molds, each indentation corresponding to a point, in succession at which pressure is to be applied to one of the teeth of the specific user and using same to form a second retainer or set of second retainers; and
instructing use of said first retainer and said second retainer causing, respectively, lifting at least one tooth of said teeth which loosens ligaments holding said tooth followed by one of rotation, translation, or tilting of said at least one tooth;
wherein said retainer matches the shape of said teeth and said gums of said specific user except for said protrusions.

16. The method of claim 15, wherein said first set of retainers are instructed for use until said tooth moves at least 1 degree.

17. The method of claim 16, wherein said first set of retainers and said second set of retainers each comprise at least six retainers.
